(19) United States
(12) Patent Application Publication
(10) Pub. No.: US 2007/0020436 A1
(43) Pub. Date: Jan. 25, 2007

(54) Roofing shingle containing algae inhibiting metallic particles

(76) Inventors: Yihsien H. Teng, Westerville, OH (US); Marc B. Kuttler, Lancaster, OH (US); Lawrence J. Grubka, Westerville, OH (US)

Correspondence Address: OWENS CORNING, 2790 COLUMBUS ROAD, GRANVILLE, OH, 43023, US

(21) Appl. No.: 11/493,748

(22) Filed: Jul. 26, 2006

Related U.S. Application Data
(63) Continuation-in-part of application No. 11/066,644, filed on Feb. 25, 2005.

(51) Int. Cl. B44C 5/04

(52) U.S. Cl. 428/148; 428/143

(57) ABSTRACT

An algae resistant roofing material includes a portion that is normally exposed when the roofing material is installed on a roof. The exposed portion of the roofing material includes a substrate coated with a coating. The coating includes an upper surface that is positioned above the substrate when the roofing material is installed on the roof. The roofing material also includes an application of metallic particles applied to the upper surface of the coating. The metallic particles include at least one ingredient that inhibits the growth of algae. The metallic particles have a large surface area characterized by at least one of the following: (a) a mean Particle Irregularity Factor of at least 1.5; (b) a mean apparent density of not greater than 3.5 g/cm³; and (c) a mean specific surface area of at least 0.02 m²/g.

### CROSS-REFERENCE TO RELATED APPLICATION

This application is a continuation-in-part of co-pending U.S. Utility application Ser. No. 11/066,644, filed Feb. 25, 2005, the disclosure of which is incorporated herein by reference.

### TECHNICAL FIELD

This invention relates to roofing materials. More particularly, the invention pertains to asphalt roofing shingles having an application of unique metallic particles applied to the asphalt base material to provide algae resistance to the roofing shingle.

### BACKGROUND OF THE INVENTION

Asphalt-based roofing materials, such as roofing shingles, are installed on the roofs of buildings to provide protection from the elements. Typically, the roofing material is constructed of a substrate, an asphalt coating on the substrate, and a surface layer of mineral granules embedded in the asphalt coating.

In certain climates, particularly warm climates with high humidity, algae, fungi, and other types of microorganisms often grow on the exposed surfaces of an untreated roofing material. This algal and fungal growth is particularly prevalent in the southeastern Gulf Coast area of the United States, and has recently become increasingly prevalent in the North and Midwest regions of the United States. This algal and/or fungal growth leads to a discoloring of the exposed roofing material surfaces. The discoloration begins as dark spots of algae/fungus that develop into dark streaks and eventually cover a majority of the roof. The discoloration generally occurs over a period of years. For example, in southeastern regions of the United States, the discoloration generally becomes visible during the second or third year after the untreated roofing shingles have been applied. This discoloring is particularly noticeable and unsightly on white or light-colored roofing materials, which are often used in warm and humid climates because of their aesthetic and sun reflectivity properties.

To combat algae and/or fungi growth, it is generally known to include algae inhibiting granules on the exposed surface of the roofing material. The granules are generally coated with a ceramic coating containing copper or copper compounds as active ingredients. When wetted by rain or otherwise, the copper leaches out from the roofing material and acts as an algicide and/or a fungicide to inhibit the growth of the algae and/or fungi.

The metallic materials and compounds used to provide the algal and/or fungal resistance are generally expensive and can undesirably increase the cost of the roofing material. The cost factor is usually one of the major criteria in selecting algae inhibiting materials for application on the roofing products. Therefore, it is desirable to apply a minimal amount and less expensive active ingredients for the least cost, and achieve a satisfactory protection of the roofing products for a desired period of time. Accordingly, it would be desirable to optimize the rate of metal leaching from the roofing material by tailoring the characteristics, and preferably the chemistry, of the algae inhibiting ingredients.

### SUMMARY OF THE INVENTION

In one embodiment of the invention, an algae resistant roofing material includes a portion that is normally exposed when the roofing material is installed on a roof. The exposed portion of the roofing material comprises a substrate coated with a coating. The coating includes an upper surface that is positioned above the substrate when the roofing material is installed on the roof. The roofing material also includes metallic particles applied to the upper surface of the coating. The metallic particles include at least one ingredient that inhibits the growth of algae. The metallic particles have a large surface area characterized by at least one of the following: (a) a mean Particle Irregularity Factor of at least about 1.5; (b) a mean apparent density of not greater than about 3.5 g/cm³; and (c) a mean specific surface area of at least about 0.02 m²/g.

In another embodiment, an algae resistant roofing material includes a portion that is normally exposed when the roofing material is installed on a roof. The exposed portion of the roofing material comprises a substrate coated with a coating. The coating includes an upper surface that is positioned above the substrate when the roofing material is installed on the roof. The roofing material also includes metallic particles applied to the upper surface of the coating. The metallic particles include at least one ingredient that inhibits the growth of algae. At least about 50 wt % of the metallic particles are agglomerated particles.

In another embodiment, an algae resistant roofing material includes a portion that is normally exposed when the roofing material is installed on a roof. The exposed portion of the roofing material comprises a substrate coated with a coating. The coating includes an upper surface that is positioned above the substrate when the roofing material is installed on the roof. A layer of granules is applied to the upper surface of the coating. Metallic particles are also applied to the upper surface of the coating. The metallic particles include at least one ingredient that inhibits the growth of algae. The metallic particles have been pre-applied to the upper surface of the coating prior to the final application of the granules, such that a portion of the metallic particles are covered by the coating

In another embodiment, an algae resistant roofing material includes a portion that is normally exposed when the roofing material is installed on a roof. The exposed portion of the roofing material comprises a substrate coated with a coating. The coating includes an upper surface that is positioned above the substrate when the roofing material is installed on the roof. The roofing material also includes metallic particles applied to the upper surface of the coating. The metallic particles include at least one ingredient that inhibits the growth of algae. The metallic particles are applied to the roofing material at a rate that provides the algae inhibiting ingredient of the metallic particles in an amount within a range of from about 0.05 pounds (22.7 g) per square to about 0.20 pounds (90.8 g) per square.

In an alternate embodiment, an algae resistant roofing material includes a portion that is normally exposed when the roofing material is installed on a roof. The exposed portion of the roofing material comprises a substrate coated with a coating. The coating includes an upper surface that is positioned above the substrate when the roofing material is installed on the roof. The roofing material also includes metallic particles applied to the upper surface of the coating. The metallic particles include at least one ingredient that inhibits the growth of algae. At least about 90 wt % of the metallic particles have an aspect ratio not greater than about 1.5.

In another alternate embodiment, an algae resistant roofing material includes a portion that is normally exposed when the roofing material is installed on a roof. The exposed portion of the roofing material comprises a substrate coated with a coating. The coating includes an upper surface that is positioned above the substrate when the roofing material is installed on the roof. The roofing material also includes metallic particles applied to the upper surface of the coating. The metallic particles include at least one ingredient that inhibits the growth of algae. The metallic particles comprise elongated copper-containing particles having an aspect ratio within the range of from about 1.5 to about 200.

### BRIEF DESCRIPTION OF THE DRAWINGS

FIG. 1 is a perspective view of a roofing shingle including algae inhibiting metallic particles according to the present invention.

FIG. 2 is a cross-sectional view of the prime region of the roofing shingle taken along Line 2-2 of FIG. 1.

FIG. 3 is an enlarged cross-sectional view of a portion of the roofing shingle cross-section shown in FIG. 2.

FIG. 4 is a photograph of one type of metallic particles suitable for inclusion as part of the roofing material of the present invention. The photograph shows the unique geometry of the particles with 3-dimensional irregularity, rough surface and porosity that contribute to a large surface area.

FIG. 5 is a photograph of another type of metallic particles suitable for inclusion as part of the roofing material of the present invention, again showing the unique geometry of the irregular particles.

FIG. 6 is a photograph of another type of metallic particles suitable for inclusion as part of the roofing material of the present invention. The illustrated metallic particles include a large percentage of agglomerated particles with significant porosity and large surface area.

FIG. 7 is a schematic view of an alternate embodiment of the present invention using chopped copper wire.

### DETAILED DESCRIPTION OF THE INVENTION

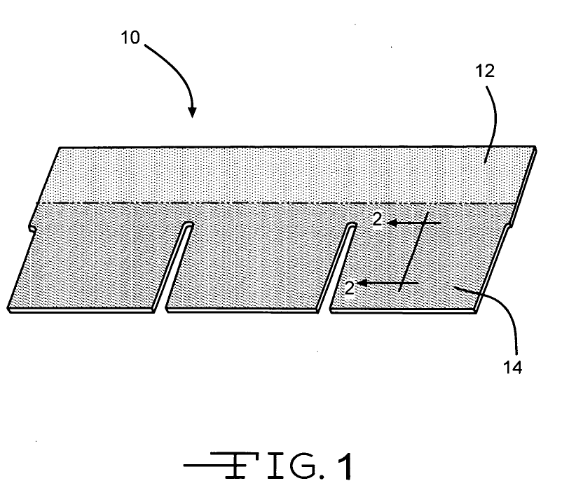

Referring now to the drawings, FIG. 1 shows an algae resistant roofing shingle according to the present invention. The illustrated roofing shingle, indicated generally at 10, is in large measure conventional in the art and is intended merely to illustrate one environment in which this invention may be used. Thus, the scope of this invention is not intended to be limited for use with the specific structure for the roofing shingle 10 illustrated in FIG. 1 or with roofing shingles in general. On the contrary, as will become apparent below, this invention may be used in any desired environment for the purposes described below. For example, it will be appreciated that any other roofing material, such as roll roofing and commercial roofing, may also be formed according to the present invention.

The roofing shingle 10 includes a headlap region 12 and a prime region 14. The headlap region 12 of the shingle 10 is the portion of the shingle 10 that is covered by adjacent shingles when the shingle 10 is installed upon a roof. The prime region 14 of the shingle 10 is the portion of the shingle 10 that remains exposed when the shingle 10 is installed upon a roof. The prime region 14 is the portion of the shingle 10 where growth of fungus, algae, or other such microorganisms may occur. The shingle 10 may have any suitable dimensions. The shingle 10 may also be divided between the headlap region 12 and the prime region 14 in any suitable proportion. For example, a typical residential roofing shingle 10 is approximately three feet (91.5 cm) wide by one foot (30.5 cm) high, with the height dimension being nearly equally divided between the headlap region 12 and the prime region 14.

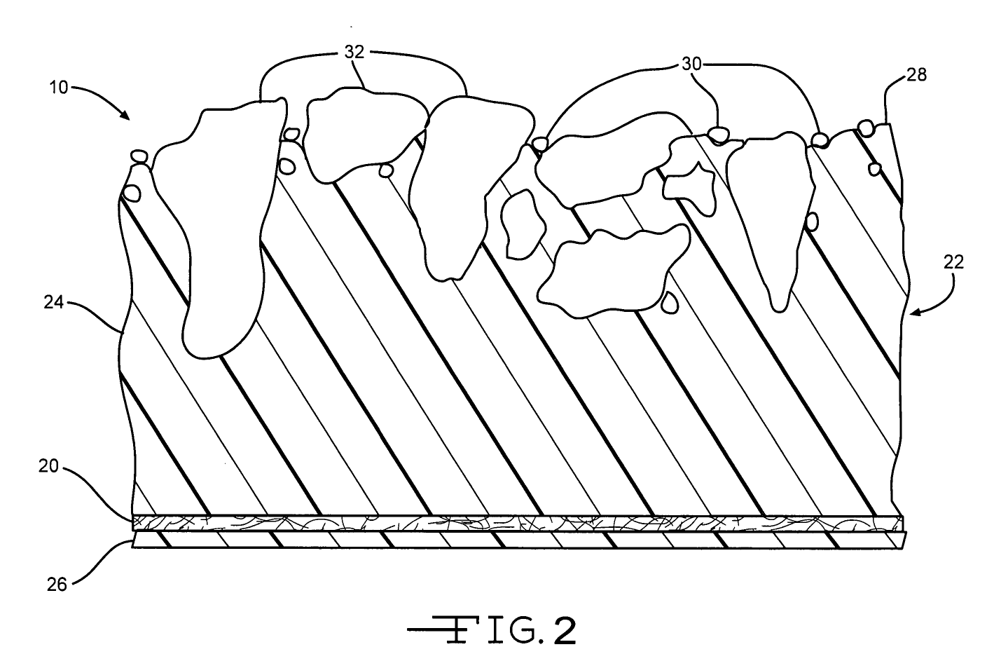

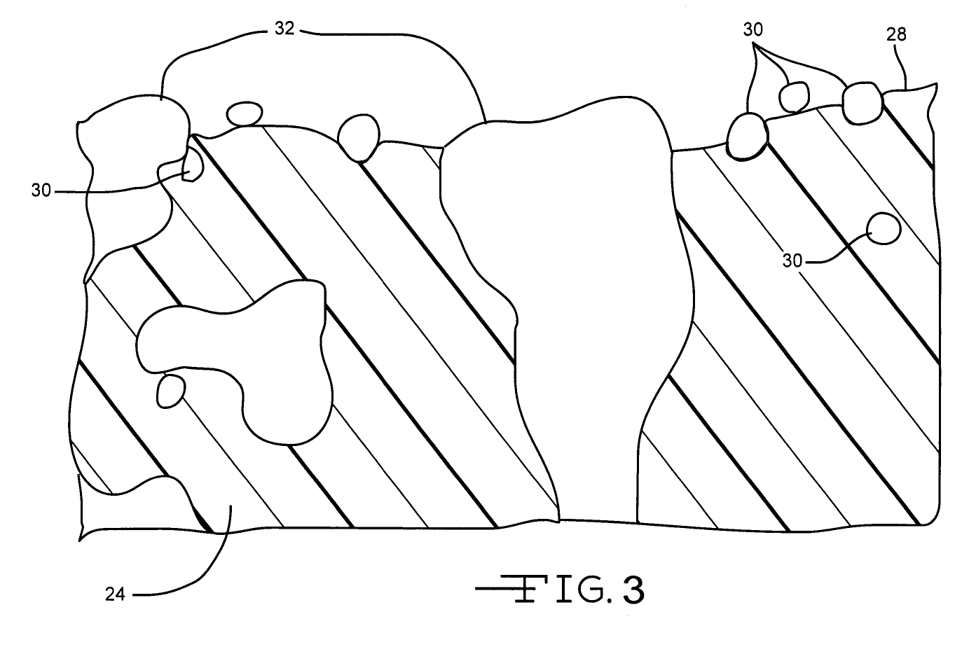

FIGS. 2 and 3 illustrate the composition of the shingle 10 of the present invention. Generally, the shingle 10 consists of a substrate 20 that is coated with a coating, indicated generally at 22. An application of metallic particles 30 is applied to the coating 22. A surface layer of granules 32 is preferably applied over the metallic particles 30 and the coating 22.

The substrate 20 can be any material suitable for providing the supporting structure in a roofing material, such as fiberglass mat or organic felt. The coating 22 can be made from any material(s) suitable for use as a roofing material coating, such as asphalt or other bituminous material, polymer, or combinations of asphalt and polymer. The coating 22 can contain any suitable filler(s) and/or additive(s). The coating 22 includes an upper region 24 and a lower region 26. The upper region 24 includes an upper surface 28. The upper region 24 and upper surface 28 are positioned above the substrate 20 when the roofing material is installed on a roof. The lower region 26 is positioned below the substrate 20 when the roofing material is installed on a roof.

An application of metallic particles 30 is applied to the upper surface 28 of the coating 22. The metallic particles 30 are applied to provide the algal and/or fungal resistance to the shingle 10. The term “algae”, as used herein, is meant to include algae and/or fungi and/or any other microorganisms that can grow on a roofing material. The metallic particles 30 may be formed from any suitable metal or metal alloy that includes at least one algae inhibiting ingredient. The active ingredient of the metallic particles 30 provides the appropriate algicidal properties desired for the algae resistant shingle 10. Preferably, the algae inhibiting ingredient of the metallic particles 30 comprises or consists essentially of copper or a copper alloy. In one embodiment, the algae inhibiting ingredient includes pure copper, in another embodiment, the ingredient includes an alloy of copper with zinc and/or tin. The metallic particles 30 can be applied by any suitable mechanism, such as with a gravimetric or volumetric feeder, and they can be applied alone or applied in a blend with the granules 32.

A surface layer of granules 32 is usually applied to the top surface 28 of the coating 22. The granules 32 can be any suitable material typically used in roofing material construction, including a mineral such as limestone, ceramic coated limestone, or other stone or ceramic coated stone material. The granules 32 can be applied in any suitable manner to the top surface 28 of the coating 22. For example, the granules 32 may be applied in a single application. The granules may also be applied in a series of applications, such as blend drops and background granules, as is common practice when multiple colors of granules 32 are applied to the roofing shingle 10.

The roofing shingle 10 contains a suitable amount of metallic particles 30 to provide algae resistance as the shingle 10 erodes over time when it is installed on a roof. Roofing shingles 10 may be manufactured to different specifications regarding the duration of protection desired. The desired duration of the algae resistance of the roofing shingle 10 of the present invention is preferably at least ten years, and more preferably, for a longer period. It will be appreciated, however, that the roofing shingle 10 may have any suitable desired wear duration. Accordingly, it will also be appreciated that the composition of the shingle 10 may be adapted accordingly to obtain the desired duration of algae resistance.

The amount of metallic particles 30 contained on the roofing shingle 10 contributes significantly to the overall cost of the roofing shingle 10. A particular advantage of one embodiment of the invention is that the amount of metallic particles 30 required on the roofing shingle 10 may be minimized as a result of a large surface area and suitable particle size, while still achieving the desired duration of algae resistance for the roofing shingle 10.

The metallic particles 30 provide algae inhibition because the algae inhibiting ingredient of the metallic particles 30 is leached, or drawn out, from the roofing shingle 10 over time. The leach rate of the algae inhibiting ingredient from the metallic particles 30 can be measured by the parts per million (ppm) of the algae inhibiting ingredient present in a sample of moisture taken from a roofing shingle 10 installed on a roof. For purposes of this invention, this leach rate measurement is determined using a “dew test”. The dew test can be carried out in either a natural weathering environment or a simulated weathering environment. In a natural weathering environment, the dew test analyzes the concentration of the algae-inhibiting ingredient of the metallic particles 30 dissolved in dew formed on the roofing shingles 10 during natural weathering. To collect dew samples for the analysis, a trough is typically installed below the lower edge of a north-facing deck covered with the roofing material, which has a runoff path of 4 feet and a pitch angle of 22 degrees. When weather permits, dew forms on the roofing material and runs off into the trough. The dew samples are collected in the morning hours (i.e. generally between 7:00 a.m. and 8:00 a.m.) before the dew evaporates from the roofing shingles 10. The dew samples are collected from roofing shingles 10 that have been naturally weathered for a minimum of 6 months, and at least 10 collections of dew samples are collected and analyzed to determine the average algae inhibiting ingredient concentration in the dew runoff. The dew runoff is preferably analyzed by inductively-coupled plasma analysis (ICP) with a detection limit to at least 0.1 ppm.

The leach rate of the algae inhibiting ingredient(s) from the metallic particles 30 on the roofing shingle 10, as determined by the above dew test method, is sufficient to provide the shingle 10 with algae resistant characteristics without prematurely depleting the metallic particles 30 from the shingle 10. The leach rate of copper in the metallic particles 30 for the ten year algae-resistant roofing shingle 10 of the present invention is preferably within the range of from about 0.3 parts per million to about 1.0 parts per million as measured in dew runoff collected from the natural weathering environment. It will be appreciated that the leach rate can be measured by a number of other methods to simulate a leach rate based on exposure to the elements, and that any other suitable rate or range of rates as well, depending on the test method used and whether any other active ingredient like zinc or tin is present. An unnecessarily lower or higher copper leach rate may result in insufficient algae-resistant protection, premature depletion of copper, or increased cost for a higher copper loading. It will also be appreciated that the leach rate may be proportionally adjusted depending upon the region of installation and desired duration of the algae resistance of the roofing shingle 10.

In one embodiment of the invention, the metallic particles 30 have a relatively large surface area. The large surface area may provide one or more benefits such as an optimized leach rate of the algae inhibiting ingredient, increased protection longevity, and reduced cost. The large surface area of the metallic particles may be characterized by at least one of the following measurements which are described below: Particle Irregularity Factor, apparent density, and specific surface area. In some embodiments, the large surface area is characterized by two or three of the measurements.

The Particle Irregularity Factor (PIF) is defined in respect to surface area change from rectangular particles based on measurements of a two-dimensional particle geometry of the length, perimeter, and area of the metallic particle 30. These measurements can be determined by image analysis or any other suitable method. The PIF of a metallic particle 30 can be calculated using the equation: PIF=(Perimeter/(2*length+2*area/length))². Particles with a rounded or rectangular geometry have lower PIF's (generally near 1 or less), while particles that are more irregular and/or have rough surfaces have higher PIF's. The metallic particles 30 of the invention have an irregular and/or rough geometry such that their mean PIF is at least about 1.5, and preferably at least about 2.0.

The apparent density of the metallic particles 30 can be measured by MPIF Standard 05 or any other suitable method. Highly irregular particles usually have low apparent densities. The metallic particles 30 of the invention have a mean apparent density of not greater than about 3.5 g/cm³, and preferably not greater than about 3.0 g/cm³. In a preferred embodiment, metallic particles that are copper-based have this apparent density.

The specific surface area of the metallic particles 30 can be measured by the BET method or any other suitable method. Highly irregular particles usually have high specific surface areas. The metallic particles 30 of the invention have a mean specific surface area of at least about 0.02 m²/g, and preferably within a range of from about 0.05 m²/g to about 1 m²/g. In a preferred embodiment, metallic particles that are copper-based have this specific surface area.

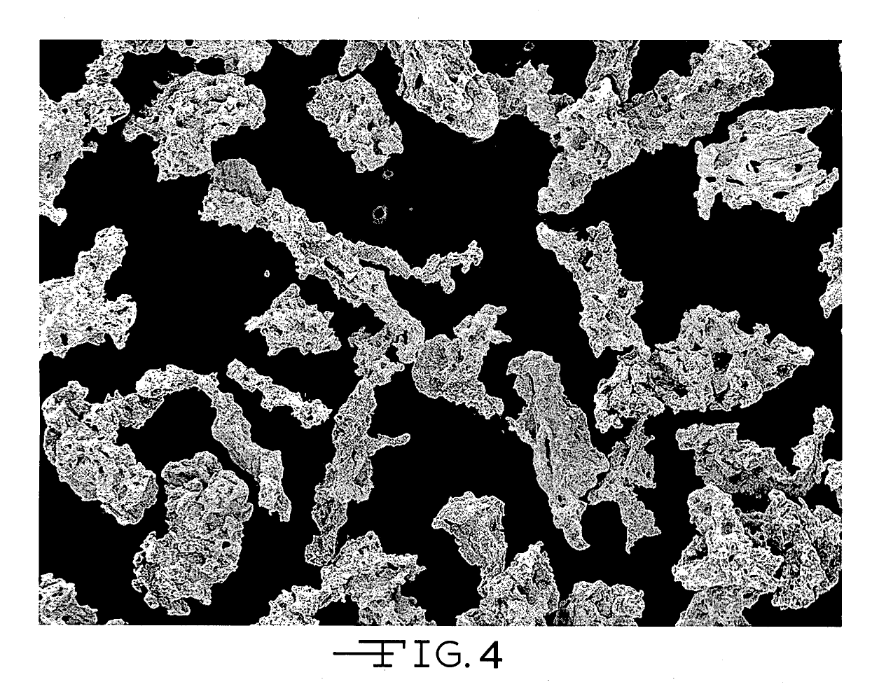

FIG. 4 shows one type of metallic particles suitable for inclusion as part of the roofing material of the present invention. The illustrated metallic particles are a powdered alloy consisting of 90% copper and 10% zinc. The photograph shows the irregular geometry of the metallic particles in three dimensions. The photograph also shows the rough surface and porosity of the metallic particles that contribute along with the irregularity to a large surface area. The PIF of the metallic particles varies within the range of from about 1.3 to about 5.3, with a mean PIF of approximately 2.3. The mean apparent density of the metallic particles is approximately 1.84 g/cm³, and the mean specific surface area of the particles is approximately 0.13 m²/g. The particle length varies from about 450 microns to about 1800 microns with a mean of approximately 1000 microns. Alternate alloy ratios may be used, such as 3%-50% tin or zinc, more or less, with the balance copper and/or other materials. In each embodiment, the percentage and amount of copper and/or alloy material is selected to provide a suitable length of protection as the materials leaches.

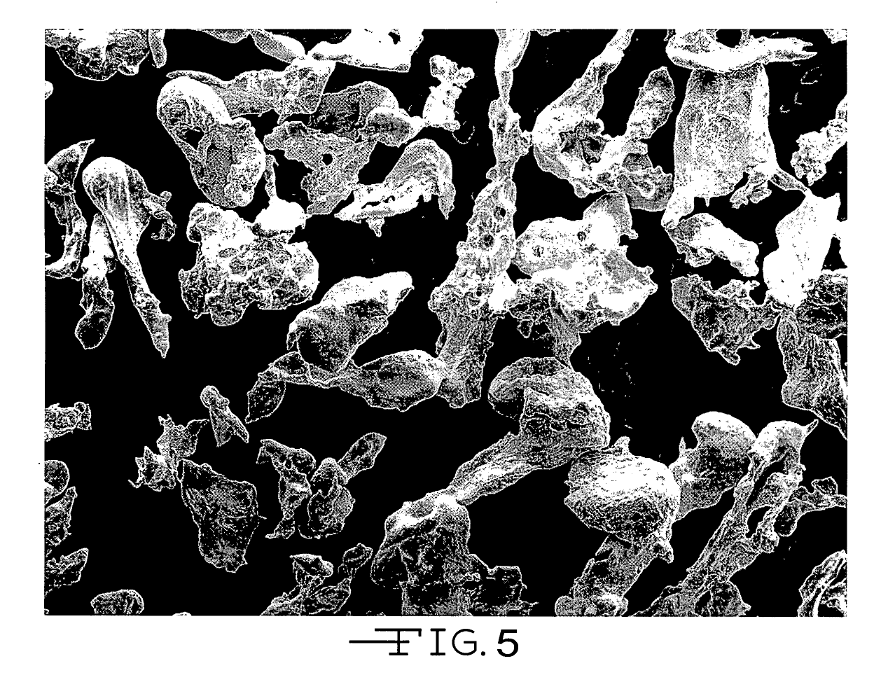

FIG. 5 shows another suitable type of metallic particles, in the form of a powdered alloy consisting of 97% copper and 3% zinc. The irregular geometry of the metallic particles can be seen in the photograph. The PIF of the metallic particles varies within the range of from about 0.9 to about 2.7, with a mean PIF of approximately 1.7. The mean apparent density of the particles is about 2.52 g/cm³, and the mean specific surface area approximately 0.10 m²/g. The particle length varies from about 150 microns to about 800 microns with a mean of approximately 280 microns.

The metallic particles 30 can have any suitable particle size. Preferably, at least about 70 wt % of the metallic particles have a length, i.e., a largest diameter, within a range of from about 50 microns to about 2500 microns. More preferably at least about 80 wt % of the metallic particles have a length within this range, and most preferably at least about 90 wt %. The particle size has an impact on the irregularity of the particles, bulk density and specific surface area. For the agglomerated particles, the particle size affects the access of water to the volume of inside pores, and hence affects the metal leach rate. On the other hand, smaller particles are more likely to be buried into the matrix of the roofing material, such as asphalt, such that the metal leach rate may be negatively affected. Larger particles are more likely to stay exposed and firmly on roofing materials against asphalt erosion during natural weathering.

Therefore, the particle size, irregularity, specific surface area, chemistry, density, loading, and burying and adhesion of the particles may be considered in material selection and application to achieve an optimal combination of performance and cost. It will be appreciated, however, that the factors may be proportionally adjusted based on the regional conditions and length of protection needed.

In another embodiment of the invention, at least about 50 wt % of the metallic particles are agglomerated particles consisting of two or more primary particles bonded together. The primary particles can be bonded together by any suitable method, such as by sintering or use of an adhesive. Preferably, the agglomerated particles are included in an amount of at least about 70 wt % of the total metallic particles, more preferably at least about 80 wt %, and most preferably at least about 90 wt %. The agglomerated particles usually have a rough surface and a relatively high porosity that enhance the access of water for metal leaching, and reduce the density of the algae inhibiting ingredient and its application rate (wt %) on the roofing material. Therefore, its efficiency can be improved and the cost reduced. The agglomerated particles preferably have a mean apparent density of not greater than about 3.5 g/cm³, and more preferably within a range of from about 1 g/cm³ to about 2.5 g/cm³. The agglomerated particles preferably have a mean specific surface area of at least about 0.02 m²/g, and more preferably within a range of from about 0.02 m²/g to about 1 m²/g. Preferably, at least about 70 wt % of the agglomerated particles have a length within a range of from about 50 microns to about 2500 microns. The primary particles bonded together to make an agglomerated particle may range in length from about 1 micron to about 200 microns, preferably in the range from about 10 microns to 100 microns. In one embodiment, an agglomerated copper particle consists of a plurality of primary copper particles having a length within a range of from about 5 microns to about 30 microns.

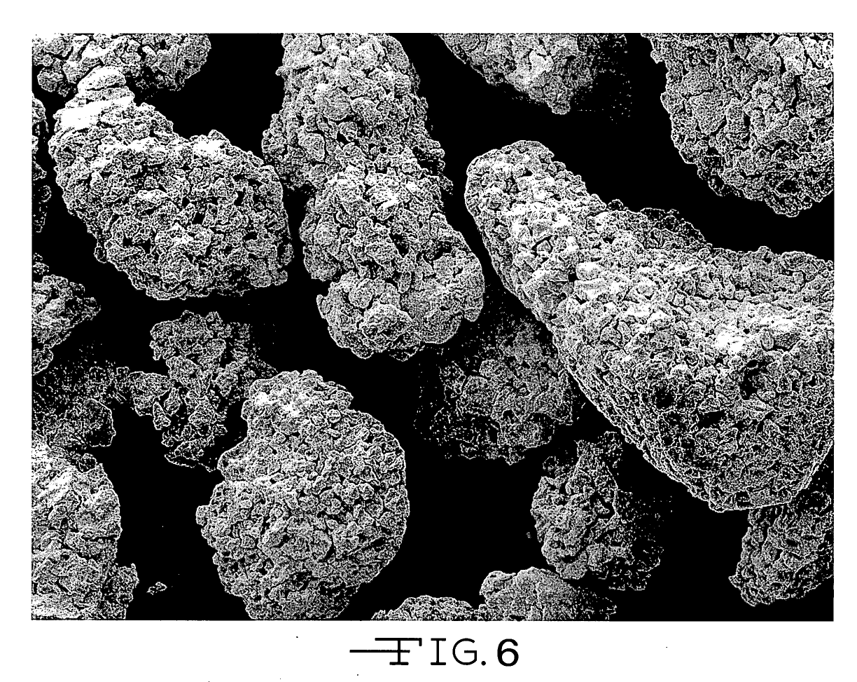

FIG. 6 shows copper particles suitable for inclusion as part of the roofing material of the present invention, the copper particles including a large percentage of agglomerated particles with significant porosity and large surface area. The particle length is from about 100 microns to about 500 microns. Most of the agglomerated particles consist of many fine particles bonded together by sintering.

The metallic particles 30 can be applied on the coating 22 of the roofing shingle 10 in any suitable manner. In one embodiment, the metallic particles 30 are preferably pre-applied to the upper surface 28 of the coating 22. The term “pre-applied”, as used herein, refers to the application of the metallic particles 30 to the coating 22 prior to the final application of the surface layer of granules 32. In this embodiment it is preferable that the metallic particles 30 be applied directly to the upper surface 28 of the coating 22 prior to the application of any granules 32. It will be appreciated, however, that it is also possible to apply the metallic particles 30 in conjunction with one or more of a series of granule 32 applications, provided that the metallic particles 30 are applied prior to the final application of the granules 32.

Pre-applying the metallic particles 30 results in a portion of the metallic particles 30 being covered by the coating 22 and/or by the granules 32, and the remaining portion left exposed. The covering of the metallic particles 30 by the coating 22 and/or the granules 32 is beneficial to extend the useful life of the metallic particles 30 and protect the roofing material from algae growth over a long period of time. The covering of the metallic particles 30 prevents loss of the metallic particles 30 that may be caused by exposure to the elements, such as rain or hail. Additionally, the covering of the metallic particles 30 helps lessen any undesirable effects of the metallic particles 30 on the aesthetics of the roofing shingle 10. The term “covered by the coating”, as used herein, refers to any particle that is positioned below the top surface 28 of the coating 22 and encapsulated within the coating 22. This term may also refer to metallic particles 30 that are covered partially by the coating 22 and partially by a granule or granules 32 applied over the metallic particles 30. Finally, this term may also refer generally to metallic particles 30 that are not visible on the top surface 28 of the coating 22. The percentage of metallic particles 30 covered by the coating 22 can vary greatly in different embodiments of the invention while still providing significant benefits. In some embodiments, at least about 30 wt %, at least about 50 wt %, or at least about 70 wt % of the metallic particles 30 are covered by the coating 22, but the invention is not limited to any particular percentage.

The percentage of metallic particles 30 covered by the coating 22 affects the leach rate of the metallic particles 30 from the roofing shingle 10. As discussed above, the leach rate affects the overall algae resistance of the roofing shingle 10. The covered metallic particles 30 are preserved within the coating 22 and/or under the granules 32 until micro-cracks form in the coating 22 as the coating 22 degrades over time or until the granules 32 erode from the surface of the shingle 10. As the coating 22 degrades and/or the granules 32 erode, the metallic particles 30 are exposed and the metal is leached from the roofing shingle 10. By covering at least a certain percentage of the metallic particles 30, this embodiment of the invention provides an advantage in that the coating 22 and/or granules 32 protects the metallic particles 30 from premature leaching. Consequently, this reduces the amount of metallic particles 30 required to achieve the desired algae resistance of the roofing shingle 10 over a long period of time.

As discussed above, some embodiments of the invention permit a reduced amount of metallic particles 30 to be applied to the roofing shingle 10 while achieving superior algae resistance on the roofing shingle 10. For the ten-year algae resistant shingle 10 discussed above, the metallic particles 30, e.g., copper or its alloys, are preferably applied to the roofing material at a rate that provides the algae inhibiting ingredient of the metallic particles 30 in an amount within the range of from about 0.05 pound (22.7 g) per square to about 0.4 pound (181.6 g) per square of roofing shingles 10, depending on the chemistry and characteristics of the metallic particles, the application process and the region of installation. It is more preferably within the range of from about 0.05 pound (22.7 g) to about 0.20 pound (90.8 g) per square. The term “square” is well recognized in the art and refers to the amount of roofing shingles 10 necessary to cover one hundred square feet (9.29 square meters) of roof surface. It will be appreciated that the amount of metallic particles 30 required per square may be proportionally adjusted to any other suitable amount depending upon the algae inhibiting ingredient used and/or the desired duration of algae resistance for the roofing shingle 10.

In an alternate embodiment of the invention, the aspect ratio of the metallic particles 30 is selected to affect the leach rate and the amount of metallic particles required. The aspect ratio of a metallic particle 30 is the ratio of the length of the longest dimension of the metallic particle to the shortest dimension of the metallic particle. Where the aspect ratio of a specified percentage of the individual metallic particles 30 is low, the surface area of the individual metallic particles 30 is minimized, and the corresponding leach rate of the metallic particles 30 is low. This slows down the leach rate, thereby extending the effective life of the metallic particle 30 with respect to leaching of the metal. Also, this allows for a reduced amount (by weight) of the metallic particles 30 to be used on the roofing shingle 10. In some embodiments, at least about 90 wt % of the metallic particles have an aspect ratio not greater than about 1.5, and preferably not greater than about 1.3. An example of a metallic particle 30 having this aspect ratio is copper shot, which is a small, bead-like particle that is nearly spherical in shape, i.e. having an aspect ratio of approximately 1.

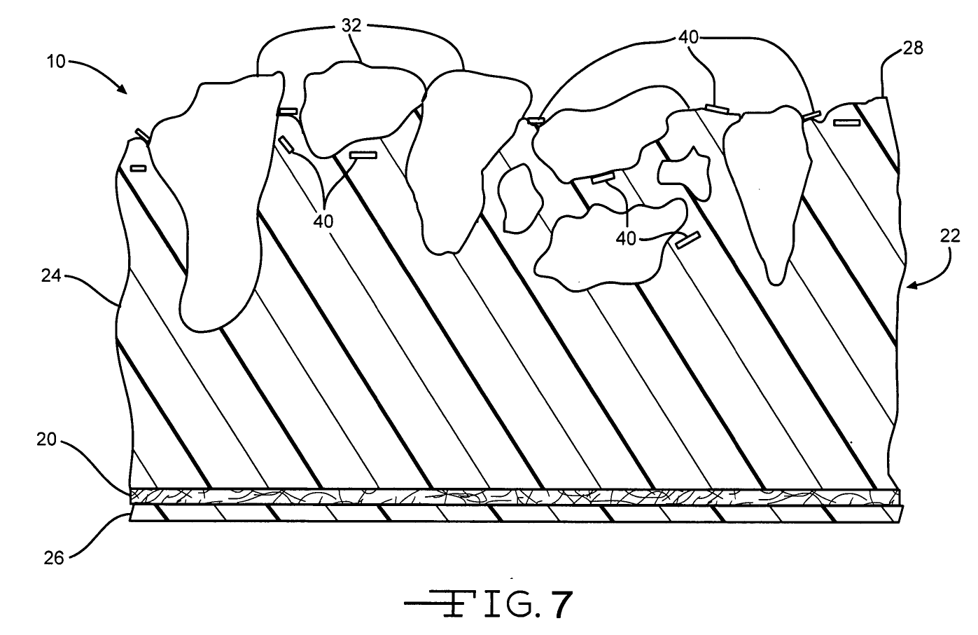

In another alternate embodiment of the invention, as shown in FIG. 7, the metallic particles are in the form of elongated copper-containing particles 40, such as recycled copper wire. The copper functions as the algae inhibiting component of the elongated particles 40. It will be appreciated that other elongated metallic particles having any other suitable algae inhibiting component may also be used, such as elongated particles formed from a copper alloy or any other suitable metal. The elongated copper-containing particles 40 function in substantially the same manner as the metallic particles 30 described above, and are also sometimes pre-applied to the asphalt coating 22 of the roofing shingle 10. The elongated copper-containing particles may also be applied within a series of granule 32 applications, as discussed above.

The elongated copper-containing particles 40 may have any suitable aspect ratio. Preferably, the aspect ratio of the copper-containing particles is within the range of from about 1.5 to about 200, and more preferably within the range of from about 10 to about 50. The elongated copper-containing particles preferably have a substantially circular cross-section, although it will be appreciated that the copper-containing particles may have any other suitable cross-sectional shape as well. The diameter of the cross-section of the elongated copper-containing particles is preferably within the range of from about 0.050 mm to about 1.5 mm.

A particular advantage of using the elongated copper-containing particles is the availability of the material and the subsequent cost savings associated therewith. As mentioned above, copper wire, which is readily available in scrap or recycled form, may be used to form the elongated copper-containing particles 40. Subsequently, the use of the recycled copper wire may even further reduce the manufacturing costs of the algae resistant roofing shingle 10 discussed above.

The principle and mode of operation of this invention have been described in its preferred embodiments. However, it should be noted that this invention can be practiced otherwise than as specifically illustrated and described without departing from its scope.

1. An algae resistant roofing material including a portion that is normally exposed when the roofing material is installed on a roof, the exposed portion of the roofing material comprising:
a substrate coated with a coating, the coating including an upper surface that is positioned above the substrate when the roofing material is installed on the roof; and
metallic particles applied to the upper surface of the coating, the metallic particles including at least one ingredient that inhibits the growth of algae, and the metallic particles having a large surface area characterized by at least one of the following: (a) a mean Particle Irregularity Factor of at least about 1.5; (b) a mean apparent density of not greater than about 3.5 g/cm³; and (c) a mean specific surface area of at least about 0.02 m²/g.

2. The roofing material of claim 1 wherein the metallic particles have a mean Particle Irregularity Factor of at least about 2.0.

3. The roofing material of claim 1 wherein the metallic particles have a mean apparent density of not greater than about 3.0 g/cm³.

4. The roofing material of claim 1 wherein the metallic particles have a mean specific surface area within a range of from about 0.02 m²/g to about 1 m²/g.

5. The roofing material of claim 1 wherein the metallic particles having a mean apparent density of not greater than about 3.5 g/cm³ and a mean specific surface area of at least about 0.02 m²/g, and wherein at least about 70 wt % of the metallic particles having a length within a range of from about 50 microns to about 2500 microns.

6. The roofing material of claim 1 wherein the metallic particles include copper or copper alloy as the algae inhibiting ingredient.

7. The roofing material of claim 1 wherein the metallic particles are characterized by at least two of (a), (b) and (c).

8. An algae resistant roofing material including a portion that is normally exposed when the roofing material is installed on a roof, the exposed portion of the roofing material comprising:
a substrate coated with a coating, the coating including an upper surface that is positioned above the substrate when the roofing material is installed on the roof, and
metallic particles applied to the upper surface of the coating, the metallic particles including at least one ingredient that inhibits the growth of algae, wherein at least about 50 wt % of the metallic particles are agglomerated particles.

9. The roofing material of claim 8 wherein the metallic particles have a mean apparent density of not greater than about 3.5 g/cm³.

10. The roofing material of claim 9 wherein the metallic particles have a mean specific surface area of at least about 0.02 m²/g.

11. The roofing material of claim 10 wherein at least about 70 wt % of the metallic particles having a length within a range of from about 50 microns to about 2500 microns.

12. The roofing material of claim 8 wherein the metallic particles include copper or copper alloy as the algae inhibiting ingredient.

13. An algae resistant roofing material including a portion that is normally exposed when the roofing material is installed on a roof, the exposed portion of the roofing material comprising:
a substrate coated with a coating, the coating including an upper surface that is positioned above the substrate when the roofing material is installed on the roof;
a layer of granules applied to the upper surface of the coating; and
metallic particles applied to the upper surface of the coating, the metallic particles including at least one ingredient that inhibits the growth of algae, where the metallic particles have been pre-applied to the upper surface of the coating prior to the final application of the granules, such that a portion of the metallic particles are covered by the coating.

14. The roofing material of claim 13 wherein the metallic particles include copper or copper alloy as the algae inhibiting ingredient.

15. An algae resistant roofing material including a portion that is normally exposed when the roofing material is installed on a roof, the exposed portion of the roofing material comprising:
a substrate coated with a coating, the coating including an upper surface that is positioned above the substrate when the roofing material is installed on the roof; and
metallic particles applied to the upper surface of the coating, the metallic particles including at least one ingredient that inhibits the growth of algae, wherein the metallic particles are applied to the roofing material at a rate that provides the algae inhibiting ingredient of the metallic particles in an amount within the range of from about 0.05 pounds (22.7 g) per square to about 0.20 pounds (90.8 g) per square.

16. The roofing material of claim 15 wherein the metallic particles include copper or copper alloy as the algae inhibiting ingredient.

17. An algae resistant roofing material including a portion that is normally exposed when the roofing material is installed on a roof, the exposed portion of the roofing material comprising:
a substrate coated with a coating, the coating including an upper surface that is positioned above the substrate when the roofing material is installed on the roof; and
metallic particles applied to the upper surface of the coating, the metallic particles including at least one ingredient that inhibits the growth of algae, wherein at least about 90 wt % of the metallic particles have an aspect ratio not greater than about 1.5.

18. The roofing material of claim 17 wherein at least about 90 wt % of the metallic particles have an aspect ratio not greater than about 1.3.

19. An algae resistant roofing material including a portion that is normally exposed when the roofing material is installed on a roof, the exposed portion of the roofing material comprising:
a substrate coated with a coating, the coating including an upper surface that is positioned above the substrate when the roofing material is installed on the roof; and
metallic particles applied to the upper surface of the coating, the metallic particles including at least one ingredient that inhibits the growth of algae, the metallic particles comprising elongated copper-containing particles having an aspect ratio within the range of from about 1.5 to about 200.

20. The roofing material of claim 19 wherein the elongated copper-containing particles have a substantially circular cross-section.

21. The roofing material of claim 18 wherein the diameter of the cross-section is within the range of from about 0.050 mm to about 1.5 mm.
